(19) United States
(12) Patent Application Publication
(10) Pub. No.: US 2015/0317359 A1
(43) Pub. Date: Nov. 5, 2015

(54) UPDATING STATISTICS IN DISTRIBUTED DATABASES

(71) Applicant: HEWLETT-PACKARD DEVELOPMENT COMPANY, L.P., Houston, TX (US)

(72) Inventors: Hoa Binh Nga Tran, Cambridge, MA (US); Benjamin M. Vandiver, Arlington, MA (US); Sumeet Suresh Keswani, Cambridge, MA (US)

(21) Appl. No.: 14/441,943

(22) PCT Filed: Nov. 14, 2012
(86) PCT No.: PCT/US2012/065063

§ 371 Date: May 11, 2015

(51) Int. Cl. G06F 17/30

(52) U.S. Cl. CPC G06F 17/30463; G06F 17/30345

(57) ABSTRACT

Updating statistics in distributed databases includes storing global statistics about at least one distributed table column distributed across multiple database nodes, where the global statistics have sensitive data for a query plan optimization process and insensitive data for the query plan optimization process, and updating the sensitive data of the global statistics more frequently than the insensitive data.

### BACKGROUND

In some databases, in response to a query for retrieving information in the database, the database management system generates multiple query plans on how to execute the query. The query plan is an ordered set of tasks used to retrieve the database's information. A query optimizer evaluates the plans and selects the plan that it considers to be optimal based on a cost model.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of a distributed database according to principles described herein.

FIG. 2 is a diagram of an example of a database node according to principles described herein.

FIG. 3 is a diagram of an example of a method for updating statistics in a distributed database according to principles described herein.

FIG. 4 is a diagram of an example of a system for updating statistics in a distributed database according to principles described herein.

FIG. 5 is a diagram of an example of an updating system according to principles described herein.

FIG. 6 is a diagram of an example of a flowchart of a process for updating statistics in a distributed database according to principles described herein.

FIG. 7 is a diagram of an example of a flowchart of a process for updating statistics in a distributed database according to principles described herein.

### DETAILED DESCRIPTION

The database management system creates the query plans based on statistics about the database's tables. However, due to the continuously changing data within the database, the statistics quickly become outdated. Unfortunately, frequently updating the statistics is time consuming and costly, often using large amounts of bandwidth and processing resources. Thus, frequently updating all of the statistics interferes with concurrently running tasks, such as the execution of other queries. Also, small changes to some of the statistics mislead the query plan optimization process to choosing non-optimal query plans. Statistics that significantly affect query plan optimization due to small changes are considered to be sensitive data, while statistics that minimally affect the query plan optimization process when small changes occur are considered to be insensitive data.

The principles described herein include a method for updating statistics in distributed databases. Such a method includes storing global statistics about at least one distributed table column distributed across multiple database nodes, where the global statistics have sensitive data for a query plan optimization process and insensitive data for the query plan optimization process, and updating, e.g., automatically, the sensitive data of the global statistics more frequently than the insensitive data.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

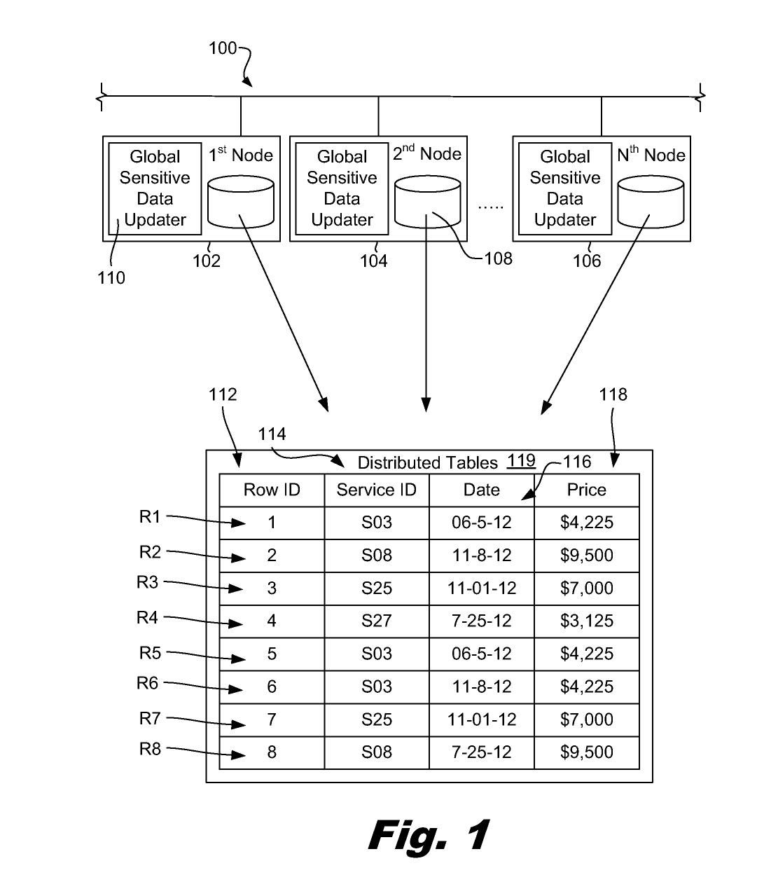

FIG. 1 is a diagram of an example of a distributed database (100) according to principles described herein. In this example, the distributed database (100) has multiple nodes (102, 104, 106) in communication with one another. Each node (102, 104, 106) has processors, memory resources (108) for storing information, and a global sensitive data updater (110) that will be discussed in more detail below. The memory resources may include main memory, cache memory, disk memory, removable memory, hard drives, optical memory media, magnetic memory media, memristor memory media, other forms of memory, or combinations thereof. The database nodes (102, 104, 106) may be physical nodes, virtual nodes, or combinations thereof.

When data is initially added or updated to the distributed database (100), the new data is stored in a common memory location. As instructed or according to a moving policy, the new data is assigned to one of the nodes for longer term storage.

The information stored collectively in the memory resources (108) of the nodes (102, 104, 106) are formatted in distributed table columns (112, 114, 116, 118). For purposes of illustration, the distributed table columns (112, 114, 116, 118) are depicted globally in FIG. 1. However, each of the rows (R1-R8) can be stored in any one or more of the database nodes (102, 104, 106). For example, rows R1, R2, and R3 can be stored in the first node (102), rows R4 and R8 can be stored in the second node, and rows R4, R5, R6, and R7 can be stored in the nth node. In alternative examples, rows R1 and R4 may be stored in the first node (102) and the second node (104).

In this example, the columns (112, 114, 116, 118) of the distributed table (119) include a row ID column (112), a service ID column (114), a date column (116), and a price column (118). Each of the columns (112, 114, 116, 118) has eight rows (R1-R8). The seller ID column (112) represents the identification number of rows in each of the columns. The service ID column (114) stores the identification number of the particular service sold. The date column (116) stores the date that the sale was made, and the price column (118) contains the price for which the service was sold.

When a query is submitted to retrieve information from the database, the database searches for the information in each of the database nodes (102, 104, 106). Retrieving information from search queries can be time consuming when the table columns include a significant number of rows and are located over a significant number of database nodes. To optimize the time to retrieve information in response to a query and to reduce its associated cost, a query plan generator creates multiple query execution plans to determine a sequence of execution tasks to execute the query. A query plan may include an order to search the database nodes and tables columns. A query plan optimizer selects the query plan it believes to take the shortest retrieval time with the lowest cost.

To create a query plan, the query plan generator uses global statistics about each of the table columns. By using global statistics, instead of local statistics that describe just the information stored locally to each node, the query plan generator can estimate the time and costs to search all of the information pertaining to the table columns to be searched. Each of the nodes (102, 104, 106) stores both the local statistics that describe the information contained locally to the node and global statistics that describe all of the information belonging to the distributed table column.

The query plan generators are more sensitive to changes to some of the global statistics than to other global statistics. For example, small changes to minimum values, maximum values, and row count statistics of the global statistics may cause query execution plans to be significantly off. Meanwhile, small changes to the number of distinct values and histograms may not significantly affect the query execution plans. The global statistics that significantly affect the query execution plans with small changes are sensitive data, while global statistics that do not significantly affect the query execution plans are considered insensitive data. To keep the sensitive data in the global statistics up to date, a global sensitive data updater (110) causes the global sensitive data to be updated relatively frequently. Such global sensitive data updates may occur more frequently than updates to the global insensitive data, independent of updates to the global insensitive data, or combinations thereof.

While the example of FIG. 1 is described with reference to a specific number of database nodes, any appropriate number of database nodes may be used. Further, while this example has been described with reference to each node containing its own global sensitive data updater, the distributed database may have any appropriate number of global sensitive data updaters. For example, just one of the nodes may have a global sensitive data updater, some of the nodes may contain global sensitive data updaters, or all of the nodes may include global sensitive data updaters. In other examples, the global sensitive data updater is separate from the database nodes. In such an example, the global sensitive data updater operates as a separate component of the database from the nodes.

In some examples, the distributed database operates as a peer to peer network where multiple nodes can operate as a server and send commands to the other nodes. The node orchestrating various processes, such as query plan generation, query plan selection, query plan execution, global sensitive data updating, other processes, or combinations thereof, can be shared across multiple nodes or switched from one node to another node as appropriate.

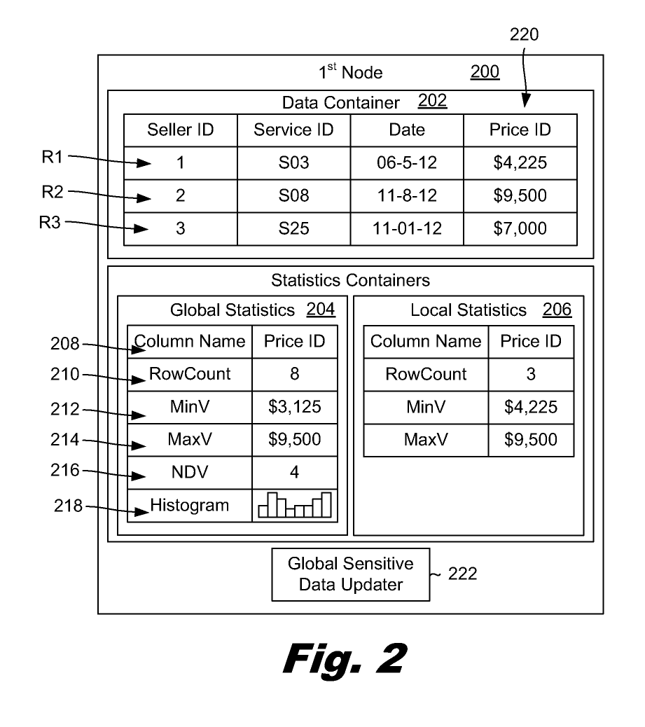

FIG. 2 is a diagram of an example of a database node (200) according to principles described herein. In this example, the database node (200) has a data container (202) that contains rows R1, R2, and R3 of the distributed table (119, FIG. 1), a global statistics container (204) that contains statistics about the distributed table globally (119, FIG. 1), and a local statistics container (206) that contains statistics about the rows (R1-R3) stored locally in the data container (202). For illustrative purposes, the global statistics container (204) and the local statistics container (206) depict just one column of data. However, the global statistics container (204) and the local statistics container (206) will include statistics about each table column in the distributed database and/or local data container (202). While the example of FIG. 2 is depicted with just four table columns, the distributed database and/or local data container (202) can include any appropriate number of table columns. Further, while the global statistics container (204) and the local statistics container (206) are described below with reference to a specific number of statistics and types of statistics, any appropriate number of statistics or type of statistics may be used in accordance with the principles described herein.

The global statistics container (204) includes the following rows of statistics: column name (208), row count (210), minimum value (212), maximum value (214), number of distinct values (216), and a histogram (218). The column name (208) indicates which column the global statistics are describing. In this case, the indicated column is the price column (118, FIG. 1). The row count (210) has a value of eight that represents the number of rows in the price column (118, FIG. 1). The minimum value (212) has a value of $3,125 from R4 of the price column (118, FIG. 1) because $3,125 is the lowest price of all of the prices listed in the price column (118, FIG. 1). Similarly, the maximum value (214) has a value of $9,500 because $9,500 is the highest value of all of the prices listed in the price column (118, FIG. 1). The number of distinct values (216) includes a value of four because the price column (118, FIG. 1) lists four distinct values. The histogram (218) graphically charts the price values listed in the price column (118, FIG. 1).

On the other hand, the local statistics container (206) contains statistics that describe just the data stored in the local node (200). Thus, the column name (208) indicates that the statistics describe the price column (220) stored locally in the data container (202). However, the row count (210) in the local statistics container just has a value of three because the local price column (220) contains just three rows. Also, the minimum value (212) contains a value of $4225 because that is the lowest value in the local price column (220). Likewise, the maximum value (214) contains $9,500 because that is the highest value in the local price column (220).

A query plan generator consults the statistics in the global statistics container (204) to generate query plans. By consulting the global statistics, the query plan generator saves time and resources by obtaining information about the distributed table columns from a single location. At least some of the global statistics affect the query plans made by the query plan generator. However, in some examples, small changes in the number of distinct values and histogram have a minimal impact on query plan generation. On the other hand, small changes in the minimum value, the maximum value, and the row count can have a significant impact on query plan generation. As a result, these small changes may otherwise mislead a query plan optimizer into selecting non-optimized query plans based on inaccurate assumptions.

A sensitive data updater (222) updates the global sensitive data (e.g., minimal value, maximum value, and row count) in the global sensitive container (204) so that the query plan generator can generate efficient query execution plans. The local statistics container (206) is updated as the data container (202) is changed, but because the information in the global statistics container (204) describes information that is distributed across multiple nodes, the global statistics are not updated as readily.

The sensitive data updater (222) may update the sensitive data on a periodic basis. In some examples, the periodic basis has an update time interval of less than five minutes. In some cases, the update time interval is one minute or less. Updating just the sensitive data, a subset of all of the global statistics, on such a frequent basis takes a short amount of time and uses minimal resources by reading the information in the local container verse communicating with all of the distributed database nodes. One of the nodes in the distributed database acts as the server and requests the local information for just the sensitive data from each of the local statistics containers (206). In such an example, the server node updates the global statistics in response to the answers to its requests. In response to updating the global statistics, the updates are sent to the other global statistic containers (204) of the other nodes. Simple requests, such as those of this example, take a short time to execute and are not likely to affect concurrent database tasks.

In other examples, the sensitive data updater (222) collects statistical data about the sensitive data after each transaction that contains an insert command, a delete command, an update command, a merge command, a load command, a copy command, or other commands that affect the value in a row or the number of rows, or combinations thereof to the data containers of any of the database nodes. In such an example, the sensitive data updater (222) can determine the changes based on these predetermined commands (e.g., delete, insert, update, merge, copy, load commands, or the like). For example, if the transaction includes a command to insert three rows into a table column of a data container and the column already includes seven rows, then the sensitive data updater (222) can determine that the new row count is ten. Likewise, if the command includes updating a row to contain a new value, the sensitive data updater (222) can determine whether the new value is below the current minimum value or above the current maximum value and update the statistics if appropriate. In this manner, the sensitive data is up-to-date at all times. In other examples, the local statistics container is consulted in response to a transaction with the predetermined commands and updates are made if appropriate.

FIG. 3 is a diagram of an example of a method (300) for updating statistics in distributed databases according to principles described herein. In this example, the method includes storing (302) global statistics about at least one distributed table column distributed across multiple database nodes, where the global statistics include sensitive data for a query plan optimization process and insensitive data for the query plan optimization process and updating (304), e.g., automatically, the sensitive data more frequently than the insensitive data.

In some examples, the global sensitive data is updated on a periodic basis. Such a periodic basis may include update time intervals of five minutes or less. In some cases, the update time intervals are one minute or less. In other examples, the global sensitive data is updated in response to a delete command to delete a row in the table column, to an insert command to insert a row in the table column, to an update command to update a value in a row in the table column, to other commands, or combinations thereof. Updating the global sensitive data may be updated by analyzing the commands in database transactions or by consulting with local statistics containers.

The sensitive data may include a minimum value, a maximum value, a row count, other sensitive data, or combinations thereof. The insensitive data may include statistics about the number of distinct values, histograms, and other appropriate insensitive data.

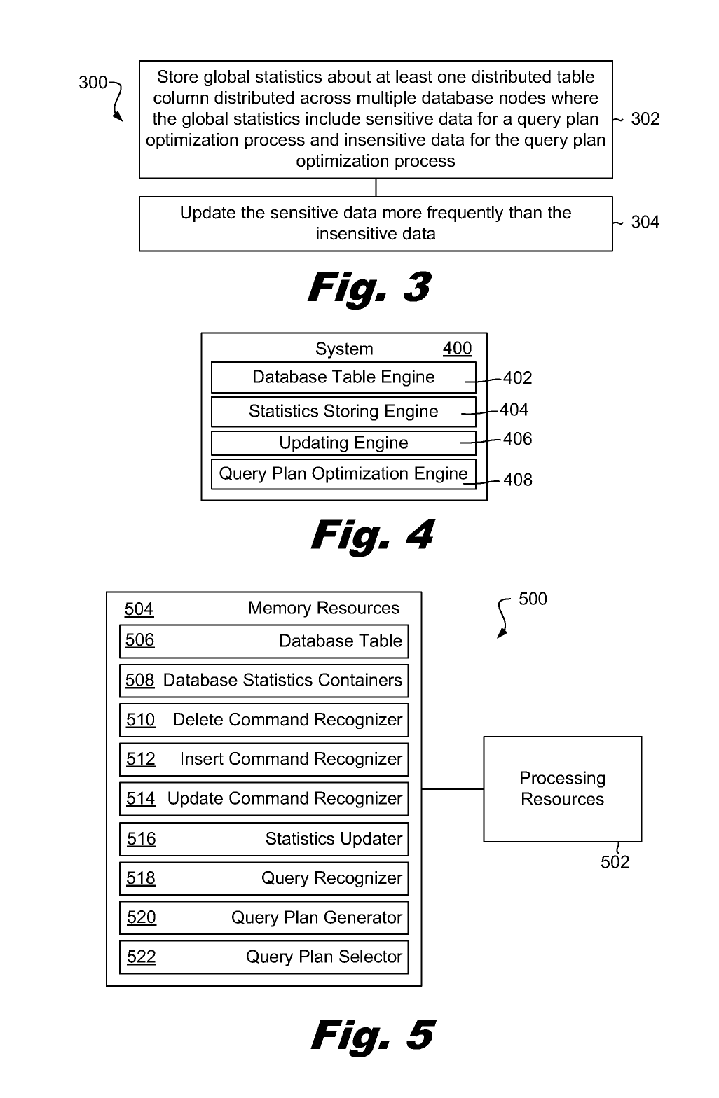

FIG. 4 is a diagram of an example of a system (400) for updating statistics in a distributed database according to principles described herein. In this example, the system (400) includes a database table engine (402), a statistics storing engine (404), an updating engine (406), and a querying plan optimization engine (408). The engines (402, 404, 406, 408) refer to a combination of hardware and program instructions to perform a designated function. Each of the engines (402, 404, 406, 408) may include a processor and memory. The program instructions are stored in the memory and cause the processor to execute the designated function of the engine.

The database table engine (402) maintains and stores the data in the table columns in the database. The rows of each of the columns may be stored in the same local database node or may be distributed across multiple database nodes. The statistics storing engine (404) stores the statistics about the table columns in the database. The statistics may be local statistics, global statistics, or combinations thereof. The global statistics are stored locally in each database node. Database users are allowed to interact with any appropriate node in the database, and thus, the global statistics are available at each node. If one of the database nodes has an error in its copy of the global statistics, the node will be removed from the distributed database and restarted. When the node is restarted, the system will copy the correct global statistics from an available node to the restarting node. However, in other examples, the global statistics are stored in a single location. The updating engine (406) updates the sensitive data on a periodic or predetermined type of transaction basis. The query plan optimization engine (408) generates query plans in response to a query for information stored in the database and selects the query plan that it considers to be the best option to execute based on a cost model.

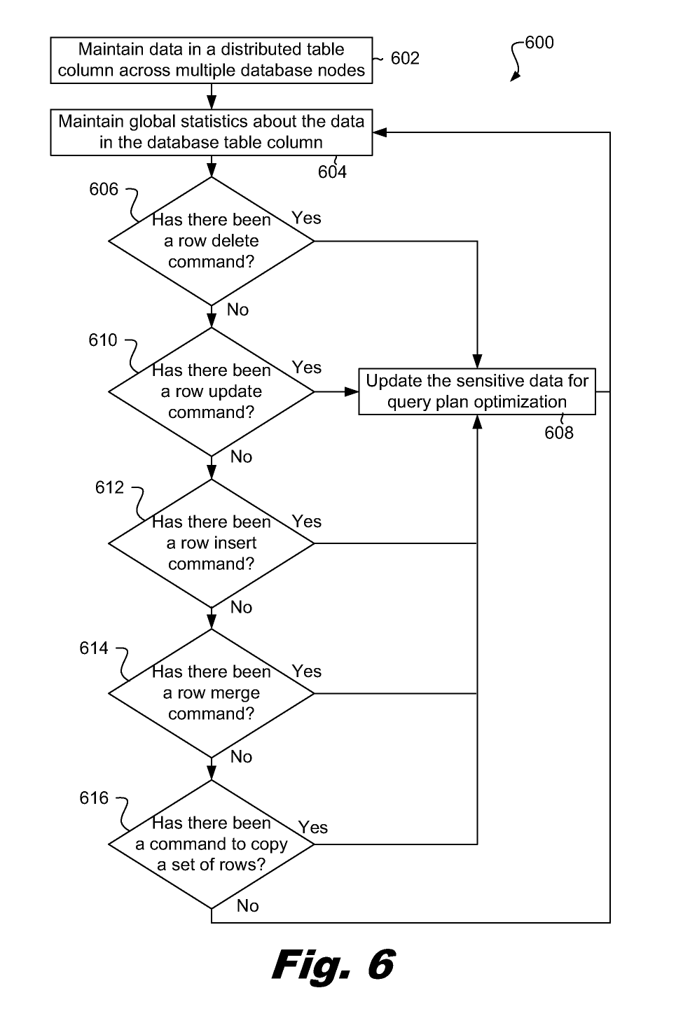

FIG. 5 is a diagram of an example of an updating system (500) according to principles described herein. In this example, the updating system (500) includes processing resources (502) that are in communication with memory resources (504). Processing resources (502) include at least one processor and other resources used to process programmed instructions. The memory resources (504) represent generally any appropriate memory capable of storing data such as programmed instructions or data structures used by the updating system (500). The programmed instructions shown stored in the memory resources (504) include a delete command recognizer (510), an insert command recognizer (512), an update command recognizer (514), a statistics updater (516), a query recognizer (518), a query plan generator (520), and a query plan selector (522). The data structures shown stored in the memory resources (504) include a database table (506) and database statistics containers (508).

The memory resources (504) include a computer readable storage medium that contains computer readable program code to cause tasks to be executed by the processing resources (502). The computer readable storage medium may be a tangible and/or non-transitory storage medium. A non-exhaustive list of computer readable storage medium types includes non-volatile memory, volatile memory, random access memory, memristor based memory, write only memory, flash memory, electrically erasable program read only memory, or types of memory, or combinations thereof.

The database table (506) is a data structure that is capable of storing data belonging to the same table across multiple database nodes. Database statistics containers (508) contain statistics that describe the data in the database tables on both a local and global level. The statistics updater (516) represents programmed instructions that, when executed, cause the processing resources (502) to update the global statistics that describe the distributed database table. The statistics updater's instructions are triggered in response to an updating policy. In this example, an update is triggered in response to transaction commands. However, in other examples, the update is triggered with an update signal that is sent at regular, periodic time intervals.

The delete command recognizer (510) represents programmed instructions that, when executed, cause the processing resources (502) to recognize a delete command to delete a row in the distributed table column. The insert command recognizer (512) represents programmed instructions that, when executed, cause the processing resources (502) to recognize an insert command to insert a row in the distributed table column. The update command recognizer (514) represents programmed instructions that, when executed, cause the processing resources (502) to recognize an update command to update a row in the distributed table column.

The query recognizer (518) represents programmed instructions that, when executed, cause the processing resources (502) to recognize when a query for information in the database is received. The query plan generator (520) represents programmed instructions that, when executed, cause the processing resources (502) to create multiple query execution plans in response to recognizing that a query has been requested. The query plan generator relies on the updated global sensitive data to generate executions plans that are accurate. The query plan selector (522) represents programmed instructions that, when executed, cause the processing resources (502) to select one of the query execution plans generated with the query plan generator that it perceived to be optimal based on completion times and estimated costs.

Further, the memory resources (504) may be part of an installation package. In response to installing the installation package, the programmed instructions of the memory resources (504) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (502) and the memory resources (504) are located within the same physical component, such as a server, or a network component. The memory resources (504) may be part of the physical component's main memory, caches, registers, non-volatile memory, or elsewhere in the physical component's memory hierarchy. Alternatively, the memory resources (504) may be in communication with the processing resources (502) over a network. Further, the data structures, such as the libraries and may be accessed from a remote location over a network connection while the programmed instructions are located locally. Thus, the updating system (500) may be implemented on a user device, on a server, on a collection of servers, or combinations thereof.

The updating system (500) of FIG. 5 may be part of a general purpose computer. However, in alternative examples, the updating system (500) is part of an application specific integrated circuit.

FIG. 6 is a diagram of an example of a flowchart (600) of a process for updating statistics in a distributed database according to principles described herein. In this example, the process includes maintaining (602) data in a distributed table column across multiple database nodes and maintaining (604) global statistics about the data in the database table column.

The process also includes determining (606) whether a row delete command has been received to delete at least one row of one of the table columns in any of the nodes. If there has been such a command, then the sensitive data is updated (608) so that future query plan optimization processes are accurate. If no delete command is received, the process then determines (610) whether a row update command has been received to update a value in at least one row of one of the table columns in any of the nodes. If there has been such a command, then the sensitive data is updated (608) so that future query plan optimization processes are accurate.

The process also includes determining (612) whether a row insert command has been received to insert at least one row of one of the table columns in any of the nodes. If there has been such a command, then the sensitive data is updated (608) so that future query plan optimization processes are accurate. If no insert command is received, the process then determines (614) whether a row merge command has been received to merge multiple rows together in one of the table columns in any of the nodes. If there has been such a command, then the sensitive data is updated (608) so that future query plan optimization processes are accurate.

The process also includes determining (616) whether a command to copy a set of rows has been received. If such a command has been received, then the sensitive data is updated (608) so that future query plan optimization processes are accurate. If none of these commands are received, the process continues maintaining (604) the global statistics.

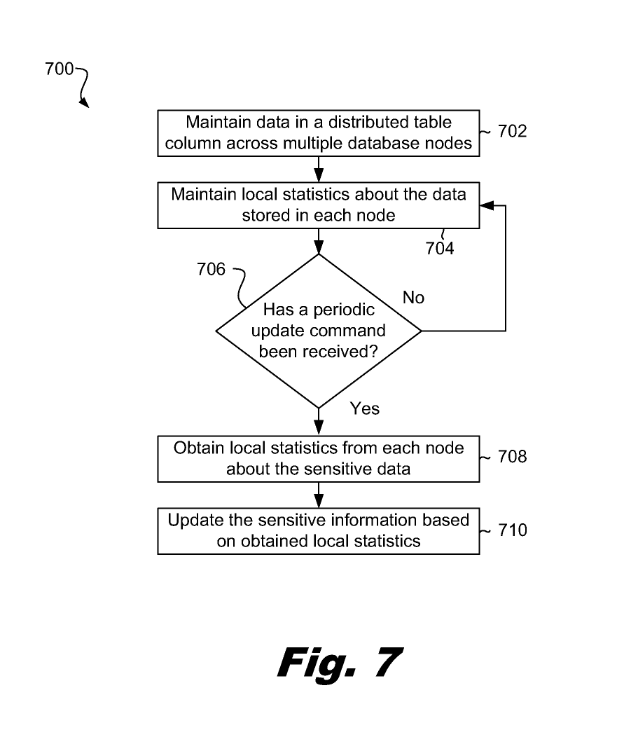

FIG. 7 is a diagram of an example of a flowchart (700) of a process for updating statistics in a distributed database according to principles described herein. In this example, the process includes maintaining (702) data in a distributed table column across multiple database nodes and maintaining (704) local statistics about the data stored in each node. The process also includes determining (706) whether a periodic update command has been received. If not, then the process continues to maintain (704) local statistics about the data stored in each node. However, if an update command has been received, then the process includes obtaining (708) local statistics from each node about the sensitive data and updating (710) the sensitive information based on obtained local statistics.

While the examples above have been described with reference to a specific database architecture, any appropriate database architecture may be used in accordance with the principles described herein. Further, while the examples above have been described with query plan generators that are sensitive to specific types of global statistics, any appropriate query plan generator that is sensitive to other types of global statistics may be used in accordance to the principles described herein. While the examples above have been described with reference to specific numbers and types of containers, any appropriate type or number of containers compatible with the principles described herein may be used.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for updating statistics in distributed databases, comprising:
storing global statistics about at least one distributed table column distributed across multiple database nodes, said global statistics comprising sensitive data for a query plan optimization process and insensitive data for said query plan optimization process; and
updating said sensitive data of said global statistics more frequently than said insensitive data.

2. The method of claim 1, wherein updating said sensitive data of said global statistics more frequently than said insensitive data includes updating said sensitive data on a periodic basis.

3. The method of claim 2, wherein said periodic basis comprises an interval of less than five minutes.

4. The method of claim 2, wherein updating said sensitive data on a periodic basis includes obtaining sensitive data from local statistics from each database node containing at least of a portion of said distributed table column.

5. The method of claim 1, wherein updating said sensitive data of said global statistics more frequently than said insensitive data includes updating said sensitive data in response to a delete command to delete a row in said distributed table column.

6. The method of claim 1, wherein updating said sensitive data of said global statistics more frequently than said insensitive data includes updating said sensitive data in response to an insert command to insert a row in said distributed table column.

7. The method of claim 1, wherein updating said sensitive data of said global statistics more frequently than said insensitive data includes updating said sensitive data in response to an update command to update a value in a row in said distributed table column.

8. The method of claim 1, wherein said sensitive data includes a minimum value, a maximum value, a row count, or combinations thereof.

9. The method of claim 1, wherein said insensitive data includes statistics about a number of distinct values and histograms.

10. A system for updating statistics in distributed databases, comprising:
a global statistics storing engine to store statistics about a distributed table column in a distributed database, said global statistics including sensitive data for optimizing query plans and insensitive data for optimizing query plans;
an updating engine to update said sensitive data of said global statistics independently of said insensitive data; and
a query plan optimization engine to use both said sensitive data and said insensitive data.

11. The system of claim 10, wherein said updating engine obtains sensitive data from local statistics of each database node containing at least of a portion of said distributed table column on a periodic basis.

12. The system of claim 10, wherein said updating engine updates said sensitive data in response to a row delete command, a row insert command, a row update command, a row merge command, a copy command, a load row command, or combinations thereof.

13. The system of claim 10, wherein said sensitive data includes a minimum value, a maximum value, a row count, or combinations thereof.

14. A computer program product for updating statistics in distributed databases, comprising:
a tangible computer readable storage medium, said tangible computer readable storage medium comprising computer readable program code embodied therewith, said computer readable program code comprising program instructions that, when executed, causes a processor to:
store global statistics about a distributed table column in a distributed database, said global statistics comprising sensitive data that includes a minimum value, a maximum value, a row count, or combinations thereof for optimizing query plans and insensitive data for optimizing said query plan;
update said sensitive data of said global statistics independently of said insensitive data also included in said global statistics; and
use both said sensitive data and said insensitive data during a query plan optimization process.

15. The computer program product of claim 14, further comprising computer readable program code to, when executed, cause said processor to update said sensitive data of said global statistics in response to predetermined transaction commands or to obtain updates about said sensitive data from local statistics of each node in said distributed database that contains at least a portion of said distributed table column.
